(19) United States
(12) Patent Application Publication
(10) Pub. No.: US 2018/0130594 A1
(43) Pub. Date: May 10, 2018

(54) CORE FOR A 3-PHASE TRANSFORMER, AND A 3-PHASE TRANSFORMER

(71) Applicant: AEM Cores Pty Ltd, Gillman (AU)

(72) Inventors: Michael Matarazzo, Gillman (AU); Mark Ridgway, Gillman (AU)

(73) Assignee: AEM Cores Pty Ltd, Gillman (AU)

(21) Appl. No.: 15/574,691

(22) PCT Filed: May 18, 2016
(86) PCT No.: PCT/AU2016/000169

§ 371 Date: Nov. 16, 2017

(30) Foreign Application Priority Data
May 18, 2015 (AU) 2015901787

(51) Int. Cl. H01F 27/26; H01F 27/245; H01F 27/30; H01F 27/25; H01F 30/12

(52) U.S. Cl. CPC H01F 27/263; H01F 27/2455; H01F 30/12; H01F 27/25; H01F 27/306

(57) ABSTRACT

A core for a three-phase transformer is disclosed. The core includes: first, second and third core segments joined together to define three lengthwise extending core legs and first and second core ends disposed generally perpendicularly to the core legs. The core ends are arranged to define a Y shape. Each core segment is formed by nesting together a plurality of magnetic steel strip laminations, the laminations having end sections. The end sections of the laminations overlap such that the ratio of the thickness of the first core end to the thicknesses of the leg thickness is greater that 1:1 and less than 2:1. In one form the ratio of the thickness of the first end to the thicknesses of the leg thickness is 3:2.

### TECHNICAL FIELD

The present invention relates to laminated magnetic cores for three phase transformers and to three phase transformers made using laminated magnetic cores.

### BACKGROUND

Transformer cores of the type formed by concentrically arranging and nesting together a series of magnetic steel strip laminations are known in the art. An example of “wound” core technology is the present applicant's UNICORE® transformer core technology which may be used for core-type, single leg and shell-type, single and 3-phase distribution and general purpose transformers.

A “wound” transformer core may consist of core legs separated by core ends or yokes. The thickness of the core legs and ends is referred to as the core build-up (BUP) and is a constant parameter which is pre-determined for a given core.

A wound core is energised by a magnetising current which flows through a primary winding (e.g. copper coil) around the core. Magnetic flux flows around the core and induces a voltage into a secondary winding around the core. The magnetic flux per unit area perpendicular to the direction of magnetic flow is referred to as the magnetic flux density.

When wound cores are manufactured, individual laminations must be bent and cut and then arranged together during core assembly. The locations where the laminations are bent (i.e. stressed) in the corner regions and where the laminations are cut (forming discontinuities) are locations where a core typically exhibits its greatest losses. Core loss is defined as the electrical power expended in the form of heat within the core when the core is subjected to alternating magnetising force. The greater the core loss, the higher the magnetisation current that is required to energise the core.

It is desirable to produce an efficient wound transformer core that is capable of reducing the core loss and required magnetising current.

### SUMMARY

According to a first aspect of the invention, there is provided a core for a three-phase transformer, the core including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, each core segment formed by nesting together a plurality of magnetic steel strip laminations, the laminations having end sections,
wherein the end sections of the laminations overlap such that the ratio of the thickness of the first core end to the thicknesses of the leg thickness is greater that 1:1 and less than 2:1.

In one form the ratio of the thickness of the first end to the thicknesses of the leg thickness is 3:2.

In one form the end sections of the laminations abut to form pairs.

In one form the layers of the pairs of ends of the laminations overlap in a stacked relationship.

In one form the core legs are arranged at 120 degrees with respect to each other.

In one form the first core end thicknesses matches the second core end thickness and the core leg thicknesses match each other.

In one form each core leg has the same width.

In one form the laminations are C-shaped.

In one form the laminations are arranged in packets of at least three nested laminations.

In one form the laminations of each packet include end edges, the end edges sized and shaped such that their ends are aligned.

In one form the laminations of each packet are sized and shaped such that their end edges are staggered.

In one form the staggered end edges of the laminations abut to form pairs.

In one form each core leg includes a pair of joined core leg portions.

According to a second aspect of the invention, there is provided a core for three-phase transformer, the core including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, the first and second core end thicknesses being equal, each core segment formed by nesting together a plurality of packets of C-shaped magnetic steel strip laminations, the packets of laminations having end sections,
wherein the end sections of the packets abut to form pairs and pairs of packets overlap such that the ratio of the thickness of the first core end to the thicknesses of the leg thickness is 3:2.

In one form the ends of the packets terminate in end edges and the end edges are angled at 120 degrees with respect to edges of the packets.

According to a third aspect of the invention, there is provided a three-phase transformer, the transformer including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, each core segment formed by nesting together a plurality of magnetic steel strip laminations, the laminations having end sections; and
first, second and third coils, the first coil coiled around the first core leg, the second coil coiled around the second core leg and the third coil coiled around the third core leg,
wherein the end sections of the laminations overlap such that the ratio of the thickness of the first core end to the thicknesses of the leg thickness is greater that 1:1 and less than 2:1.

In one form the ratio of the thickness of the first end to the thicknesses of the leg thickness is 3:2.

In one form the end sections of the laminations abut to form pairs.

In one form layers of the pairs of ends of the laminations overlap in a stacked relationship.

In one form the core legs are arranged at 120 degrees with respect to each other.

### BRIEF DESCRIPTION OF DRAWINGS

Embodiments of the present invention will be discussed with reference to the accompanying drawings wherein:

FIG. 1 is a diagrammatic perspective view showing a transformer core according to an embodiment of the invention;

FIG. 2 is a perspective view of a magnetic steel strip lamination which forms a part of the transformer core shown in FIG. 1;

FIG. 3 is a perspective view of a packet comprised of the lamination shown in FIG. 2;

FIG. 4 is a perspective view of two of the packets as generally illustrated in FIG. 3;

FIG. 5 is a perspective view showing two of the pairs of packets as illustrated in FIG. 4 assembled in an overlapping relationship;

FIG. 6 is a similar view to that of FIG. 5 and shows a third pair of packets assembled over the two pairs shown in FIG. 5;

FIG. 7A is a plan view of the assembly of FIG. 6;

FIGS. 7B, 7C and 7D are plans views similar to that of FIG. 7A, but showing alternatives;

FIG. 8 is a side view of the assembly of FIG. 6;

FIG. 9 is an isometric view of a transformer core (or a sub-assembly of a larger transformer core according to the invention);

FIGS. 10 and 11 are perspective and side views respectively of six packets for forming an alternative transformer core according to a further embodiment of the invention;

FIGS. 12A, 12B and 12C are similar perspective views to those of FIGS. 2, 3 and 4, but show magnetic steel strip laminations which form a part of an alternative transformer core having a top view, as shown in FIG. 7B;

FIGS. 12D to 12F are similar to those of FIGS. 4 to 6 but show magnetic steel strip laminations which form a part of the alternative transformer core of FIGS. 12A to 12C;

FIGS. 13A and 13B are isometric views of core alternative segments, or portions of segments, of a transformer core;

FIG. 14 is an isometric view showing a pair of coil support frames for assisting with assembling a transformer core and a transformer;

FIGS. 15 and 16 are isometric and end views respectively of a transformer assembly apparatus;

FIG. 17 is a similar view to that of FIG. 15 but also shows alignment plates; and

FIGS. 18 and 19 show a built up transformer on the transformer assembly apparatus of FIGS. 15 and 16.

### DESCRIPTION OF EMBODIMENTS

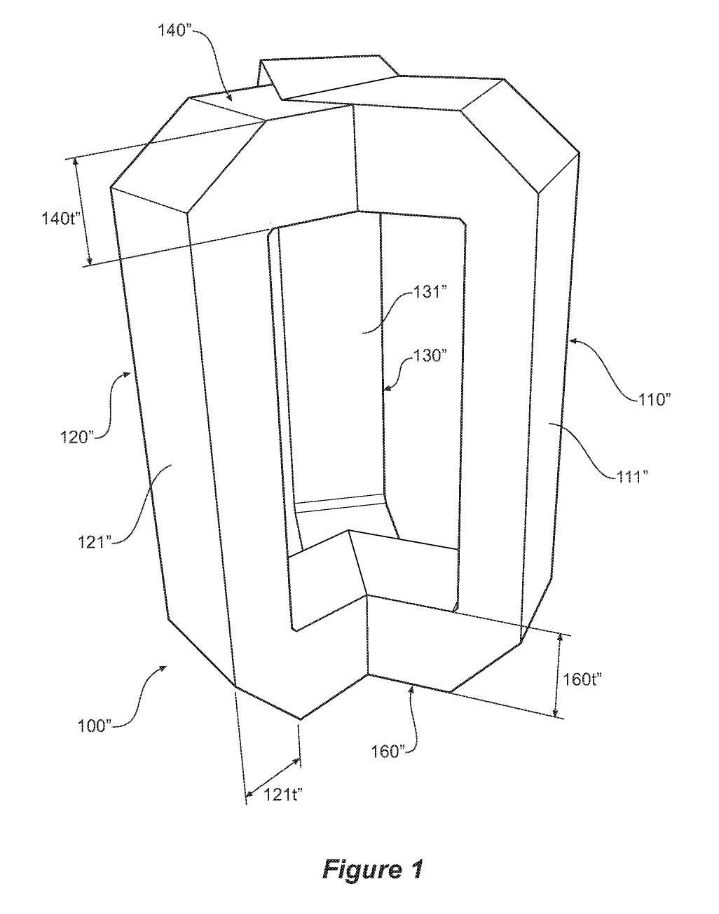

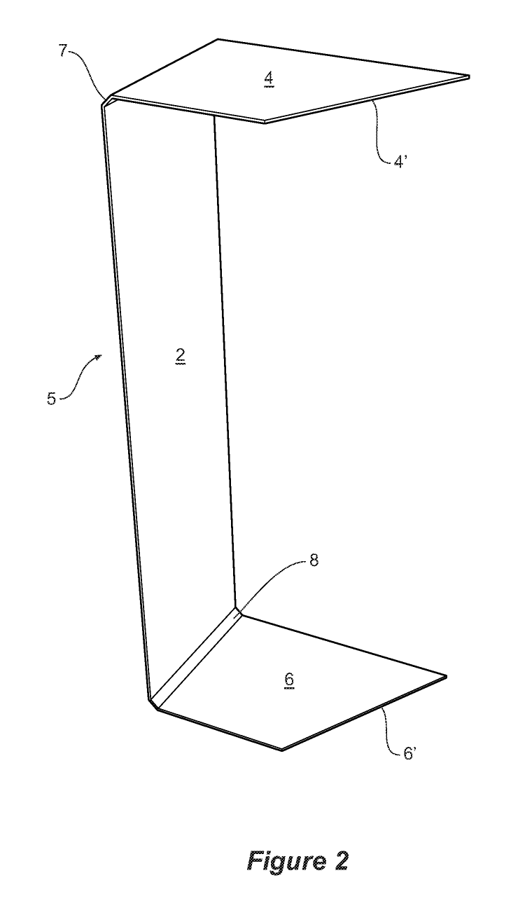

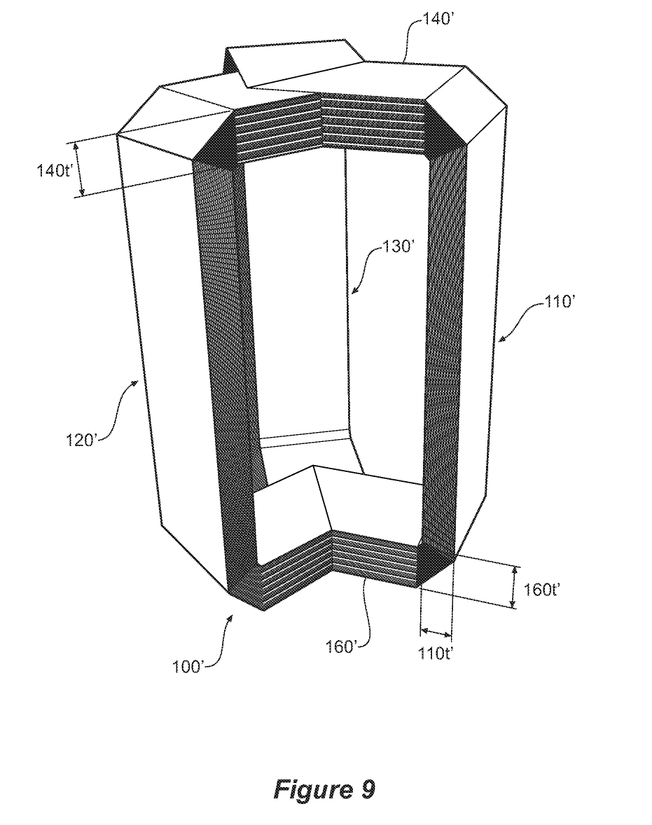

Referring to FIG. 1, a transformer core 100″ according to an embodiment of the invention is shown in a diagrammatic view. The same transformer core in a partially built up state is shown in more detail in FIG. 9 as transformer core 100′. The transformer core 100″ includes first, second and third core segments 110″,120″,130″ joined together to define three lengthwise extending core legs 111″,121″,131″ and first and second core ends 140″ and 160″. The first and second core ends 140″ and 160″ (shown at the top and bottom of FIG. 1), are disposed generally perpendicular to the core legs 111″,121″,131″. The core ends 140″,160″ are arranged to define a Y shape. The core legs have a leg thickness, such as the thickness 121t″ illustrated in FIG. 1. The first core end 140″ has a first core end thickness 140t″ and the second core end 160″ has a second core end thickness 160t″. The first and second core end thicknesses 140t″ and 160t″ are equal. Furthermore, the core leg thicknesses 121t″, 11t″ and 131t″ are also equal. Each core segment is formed by nesting together a plurality of magnetic steel strip laminations 5, the laminations having end sections 4 and 6 such as is shown in FIG. 2.

The ratio of the first end thickness 140t″ to the leg thickness 121t″ is 3:2.

Each core segment 110″,120″,130″ is formed by nesting together magnetic steel strip laminations. Individual laminations are not visible in the diagrammatic view of FIG. 1. A single lamination 5 is illustrated in FIG. 2. This lamination 5 is generally C-shaped.

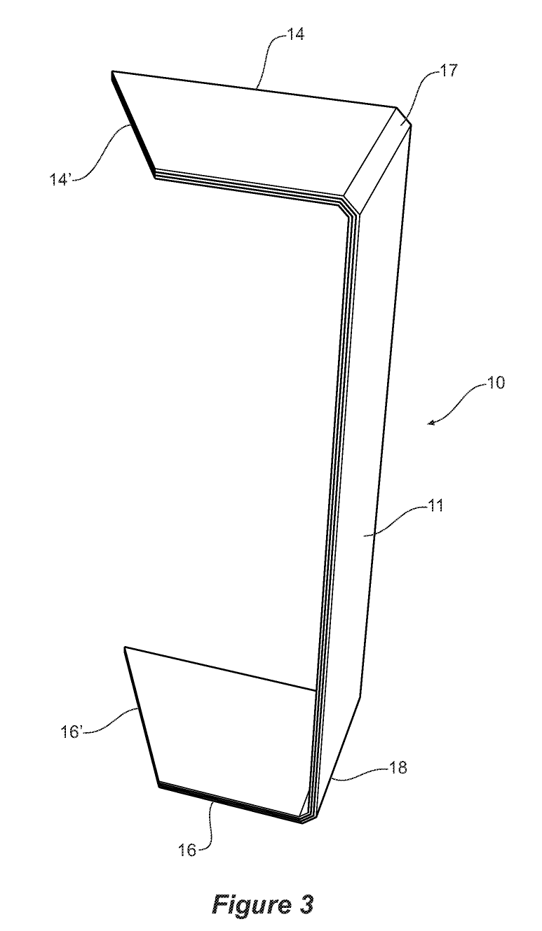

Referring to FIG. 3, a packet of laminations is shown (packet 10). Packet 10 comprises a plurality (three in the packet illustrated) of magnetic steel strip laminations 5 shown in FIG. 2. FIG. 2 shows that each magnetic steel strip lamination 5 in the packet 10 of FIG. 3 is bent and cut to form a generally C-shaped lamination having a web section or leg 2 and flange or end sections 4,6. The laminations 5 also comprise angled corner sections 7,8. The flange or end sections 4,6 are disposed generally perpendicularly to the web section or leg 2 of each lamination 5. A plurality of laminations 5 are grouped together to form the packet 10. Each packet has ‘n’ laminations, where 2≤n≤10.

Referring again to FIG. 3, it can be seen that the three nested laminations result in a packet 10 having a leg portion 10 an upper end portion 14 and a lower end portion 16. The leg portion 10 transitions to the upper and lower end portions as angled corner portions 17 and 18 respectively.

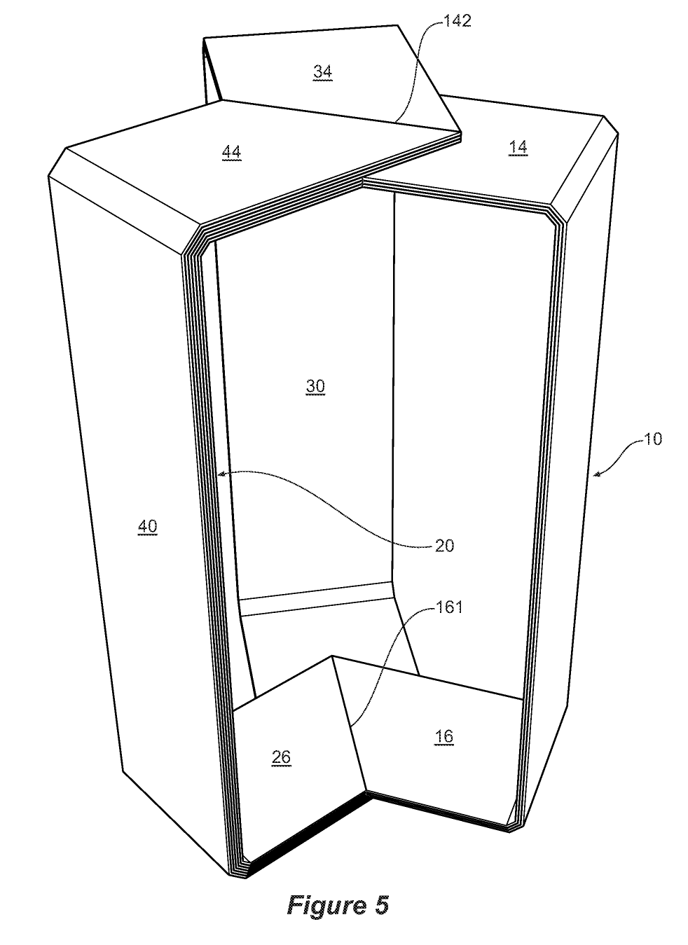

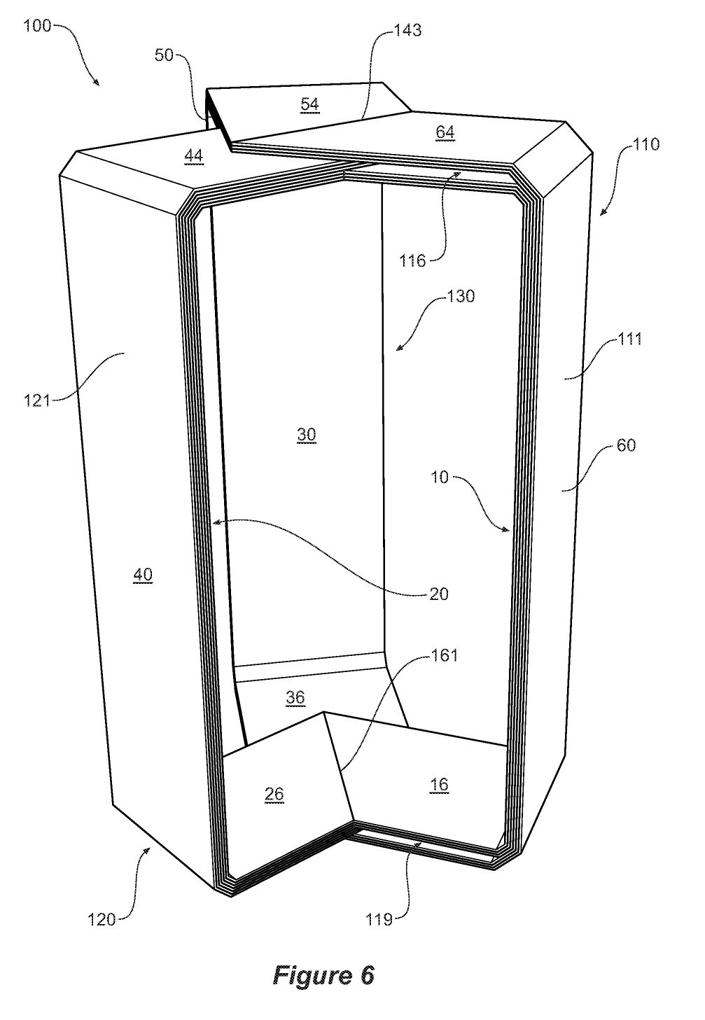

FIG. 5 shows four packets 10, 20, 30, 40 of the type shown in FIG. 3. FIGS. 6, 7A and 8 show six packets of the type shown in FIG. 3. These packets 10, 20, 30, 40, 50, 60 and their laminations 5 gradually increase in dimensions from innermost packets 10,20 to outermost packets 50,60 such that adjacent packets within a core segment may be nestably engaged. FIGS. 6, 7A and 8 show a minimum number of packets required to form a transformer core according to this embodiment of the invention. In practice, however, there will generally be ‘m’ sets of six packets, where m>2 leading to a core such as the core 100″ illustrated in FIG. 1. Thus, the assembly shown in FIGS. 6, 7A and 8 can be used as a transformer core.

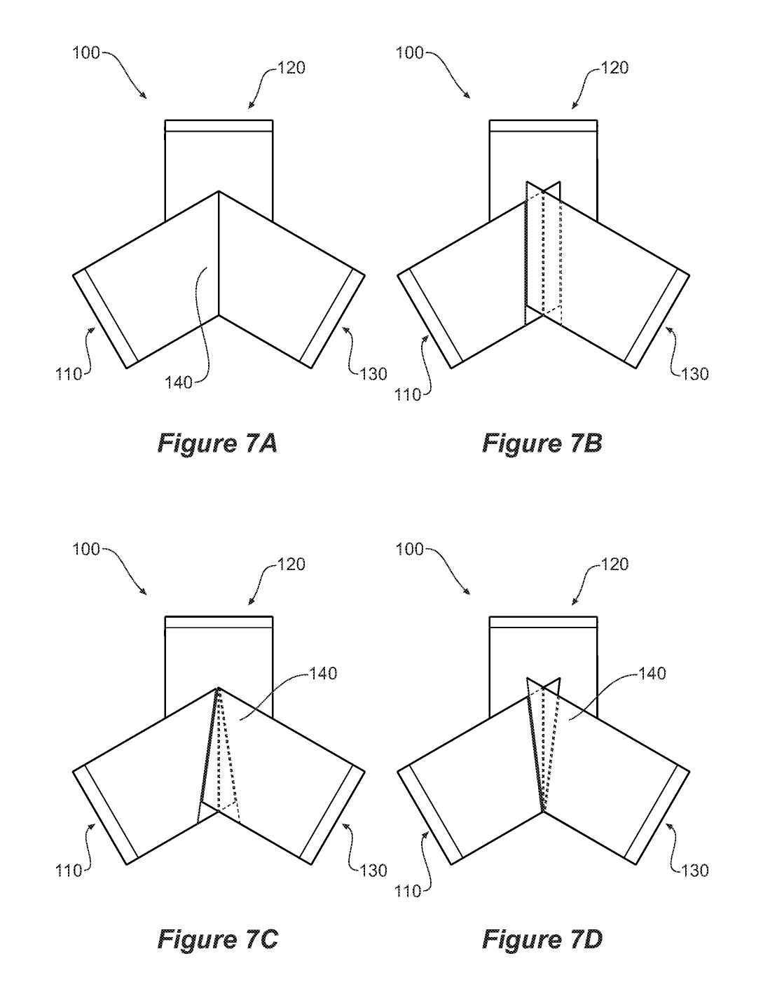

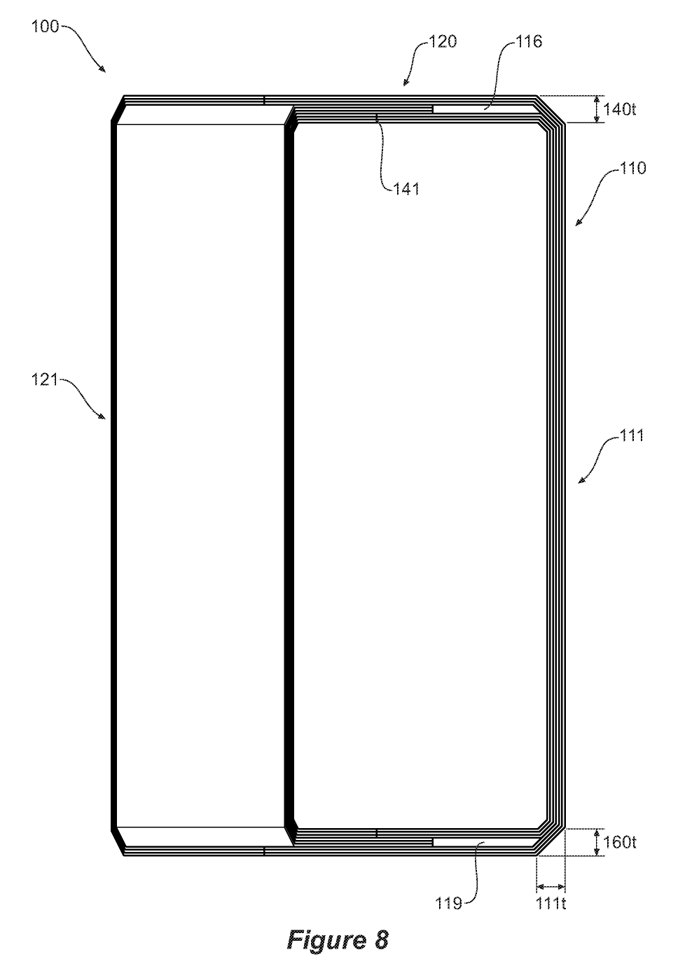

In FIG. 7A, the top view of the assembly of FIGS. 6 and 8, m the resultant Y-shape of the core end 140 is clearly shown.

The assembly shown in FIG. 9 has six sets of packets, each set including six packets. The thirty six packets shown in FIG. 9 form a core 100′. Again, the assembly of FIG. 9 can be used as a transformer core, or alternatively, the assembly of FIG. 9 can form part of a larger core having a larger leg and end build up.

Referring to FIG. 8, the set of packets of FIG. 6 is shown in a side view. This set of packets, or transformer core 100 has first and second core end build up thicknesses 140t and 160t. Slots 116,119, shown in both FIGS. 6 and 8, are created by the overlapping of packet end portions. The core leg 111 has a build up thickness 111t. The leg build up of the other legs 121 and 131 is the same as the leg build up thickness of leg 111. The ratio of the first end build up thickness 140t to the leg build up thickness 111t is 3:2.

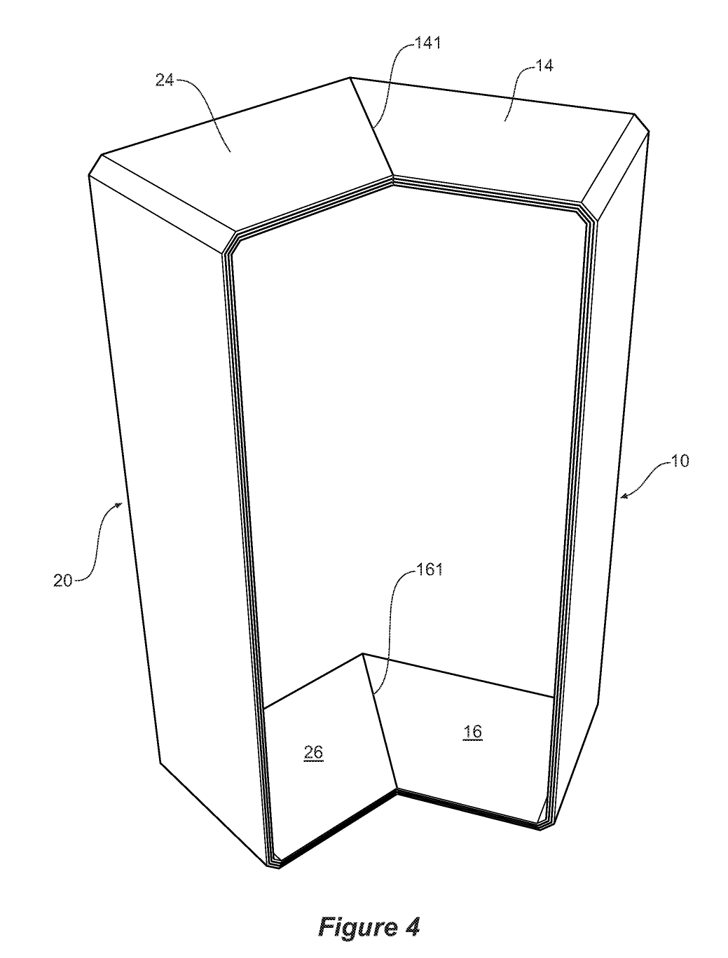

A pair of packets of laminations 10,20 is shown in FIG. 4. The packets 10,20 are disposed such that their end sections 14′,16′ abut each other to form a 120 degree V-shape, joining along join lines 141 and 161.

Referring again to FIG. 6, it can be seen that layers of the pairs of ends 14′,16′ overlap in a stack relationship. That is, one of the three pairs, pair 10,20, is interleaved between the other two of the three pairs, being the two pairs 30,40 and 50,60. This interleaving creates a lower loss flux path.

The mix of abutment and overlapping or interleaving reduces the end build up that would otherwise occur if all end sections overlapped, as is clear in FIG. 9 for instance, and results in the ratio of the first end thickness 140t′ to the leg thickness 121t′ being 3:2.

FIG. 6 shows core end joints 143 and 141. The core end joint 143 is similar to the core end joint 141 shown in FIG. 4 but is angled at an angle of 60 degrees with respect to core end joint 143. Thus, the core end 140 includes three core end joints 141, 142 and 143 shown in FIGS. 4, 5 and 6 respectively that are each mutually orientated at 60 degrees. Similarly, at the lower core end 160, core end joints 161 to 163 are each orientated at 60 degrees with respect to each other. By having the core end joints, angularly not aligned, and by using the interleaving as described above, a lower loss flux path is provided.

Referring again to FIG. 6, upper end portions 44, 54 and 64 of packets 40, 50 and 60 are shown. The end portion 54 has a different length than the end portion 64. This is also the case for other packet end portions so as to achieve the leg geometry for legs 111, 121 and 131 as illustrated. The lower end portions 16, 26 and 36 are also illustrated in FIGS. 6, those end portions being end portions of packets 10, 20 and 30. Again, the lower end portions have different lengths.

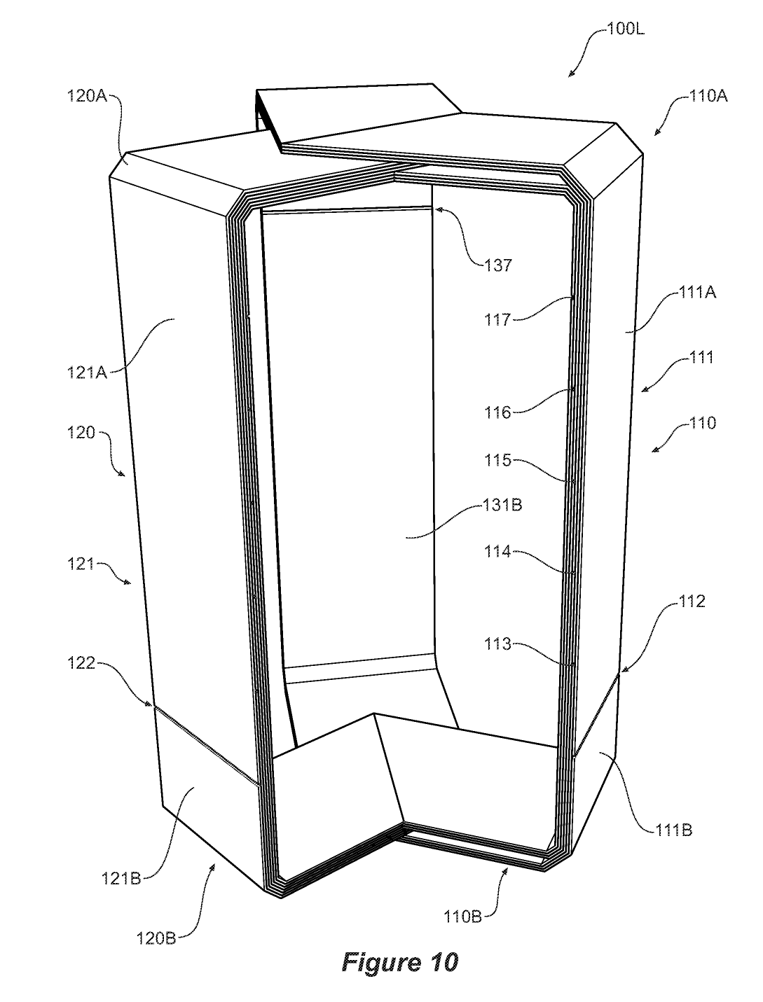

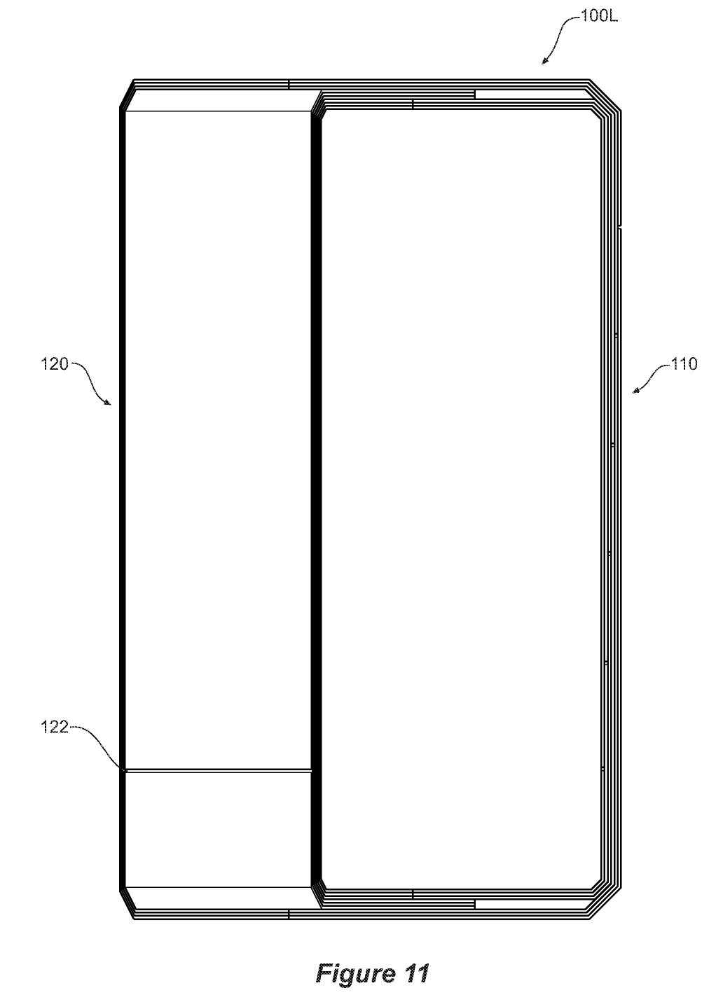

Referring now to FIGS. 10 and 11, an alternative embodiment of the invention is shown where each C-shape packet includes a pair of joined L-shaped packet portions, each packet portion comprising a leg portion and one end section from the pair of end sections. An advantage of the L-shaped packet portions, which result in a split leg having two leg portions, is that a phase winding can be wound independently of the core leg. For instance, a mandrel may be used. After the phase winding has been wound, the two leg portions can be joined by insertion through opposite ends of the phase winding. This allows a two-piece transformer core to be formed, each piece of the transformer core having a core end and three joinable core leg portions.

Referring to FIGS. 10 and 11 in more detail, it can be seen that the transformer core 100L (or sub-assembly of a larger transformer core) has first, second and third core segments 110, 120 and 130, each of which is separable in so as to form three pairs of leg portions 111a, 111b, 121a, 121b, 131a and 131b. Gaps 112 to 117 within the core leg 111 are shown. Similarly, there are gaps 122 to 127 in the core leg 121 and core leg 131 has gaps 132 to 137. In practice, these gaps may be closed up by pushing the leg portions towards each other to create abutments. Due to tolerancing however, there will likely be at least some gaps. By ensuring that the gaps are not aligned, that is by staggering the gaps, each gap is bridged by an overlapping (overlying) packet. This bridging or overlapping creates a lower loss flux path, as is explained in the applicant's earlier application titled A Wound Transformer Core and having international Application No. PCT/AU2014/000864, the contents of which is hereby incorporated by reference.

Referring now to FIGS. 7B, 12A, 12B, 12C and 13C, an alternative embodiment of the invention is shown.

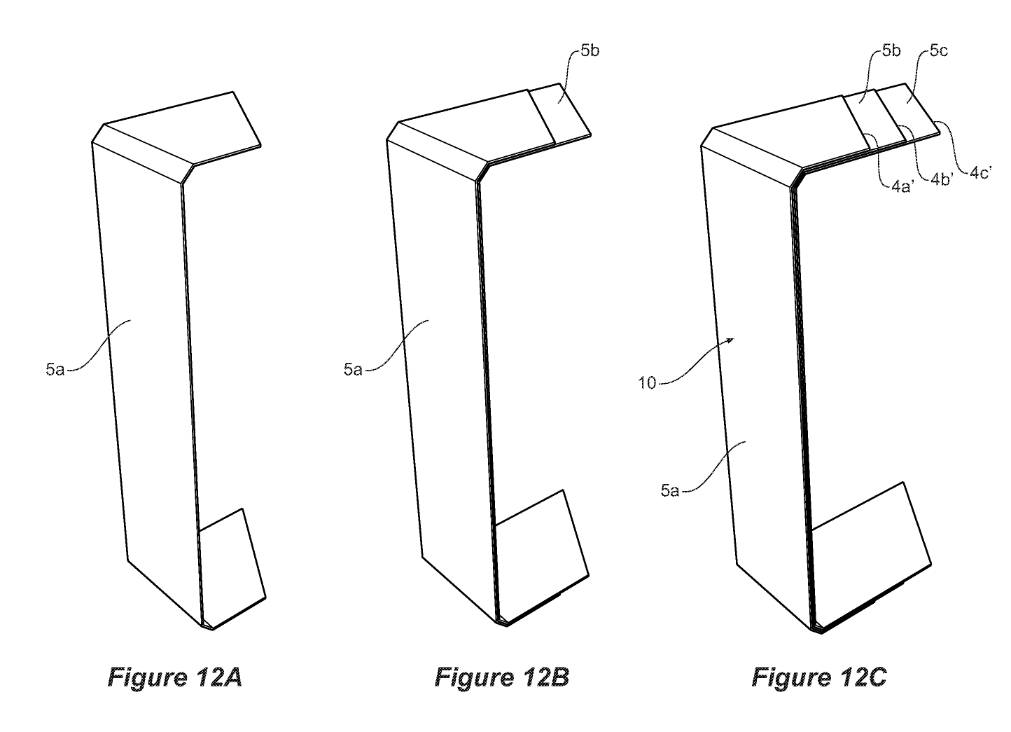

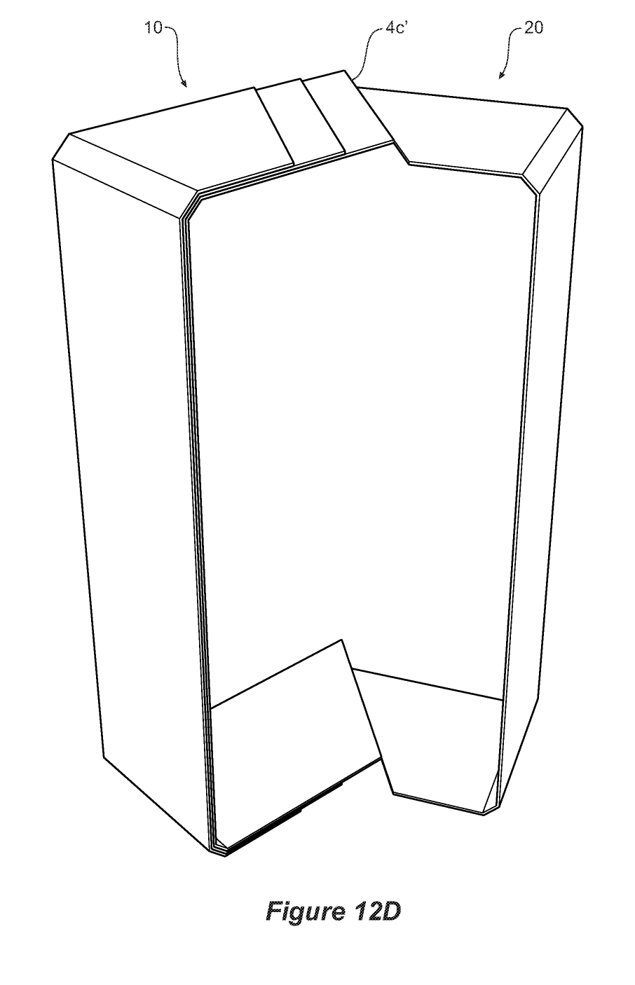

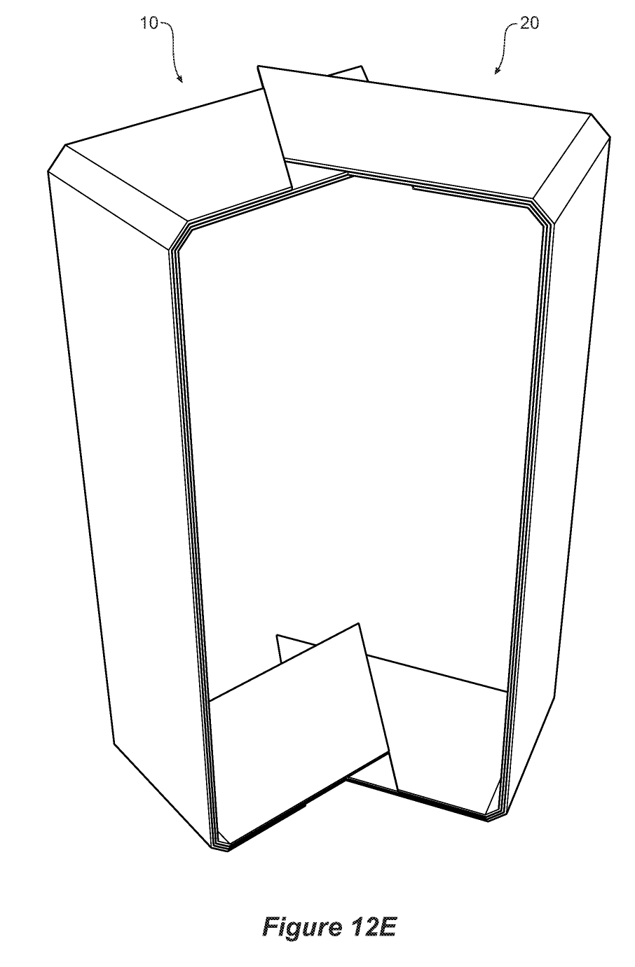

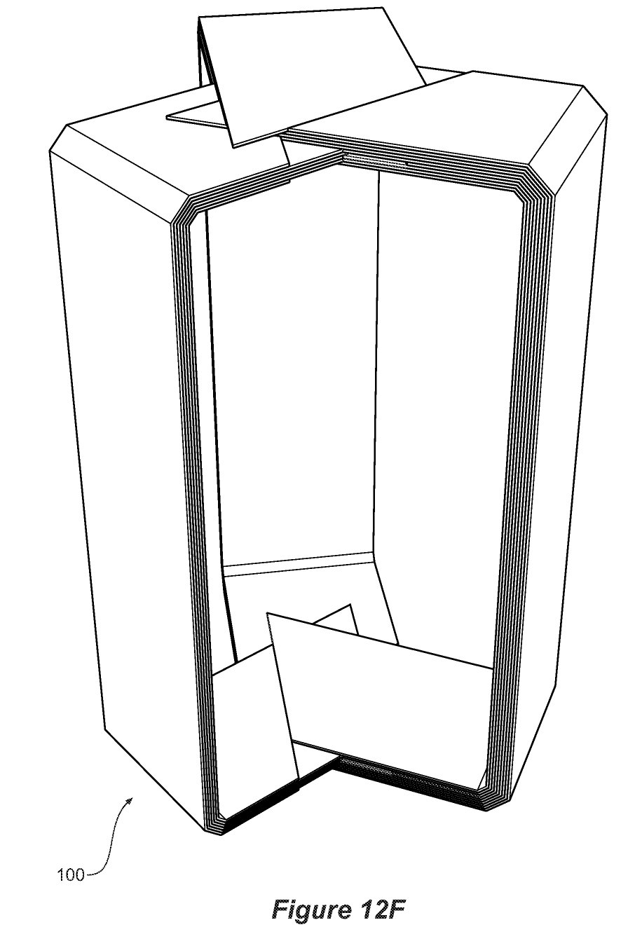

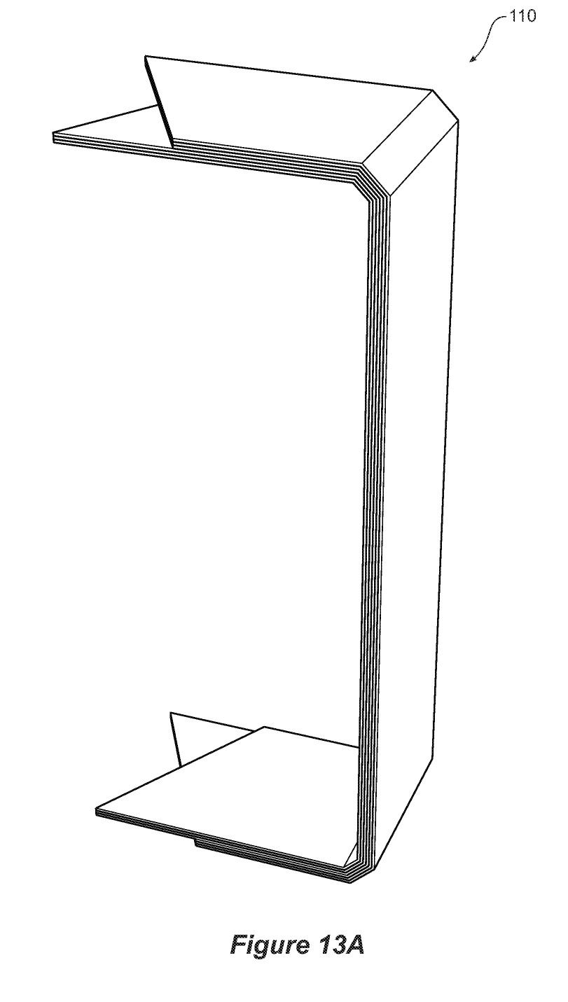

With this embodiment of the invention, three laminations 5a, 5b and 5c are nested together to form a packet 10, as is shown progressively from FIGS. 12A to 12C. While in FIGS. 12A to 12C the build up of laminations is shown with lamination 5c being inserted last, in practice lamination 5a may be positioned or nested last.

As can be seen in FIG. 12C, the lamination end edges 4a′,4b′,4c′ are staggered.

Referring now to FIG. 12D and FIG. 12E, it can be seen that the staggered end edges 4a′,4b′,4c′ abut corresponding end edges to form pairs.

Now referring to FIG. 12F, the beginnings of the assembly of three core segments from the packets 10 and 20 shown in FIGS. 12C, 12D and 12E (and from a third packet 30 not shown but similar to packets 10 and 20) can be seen.

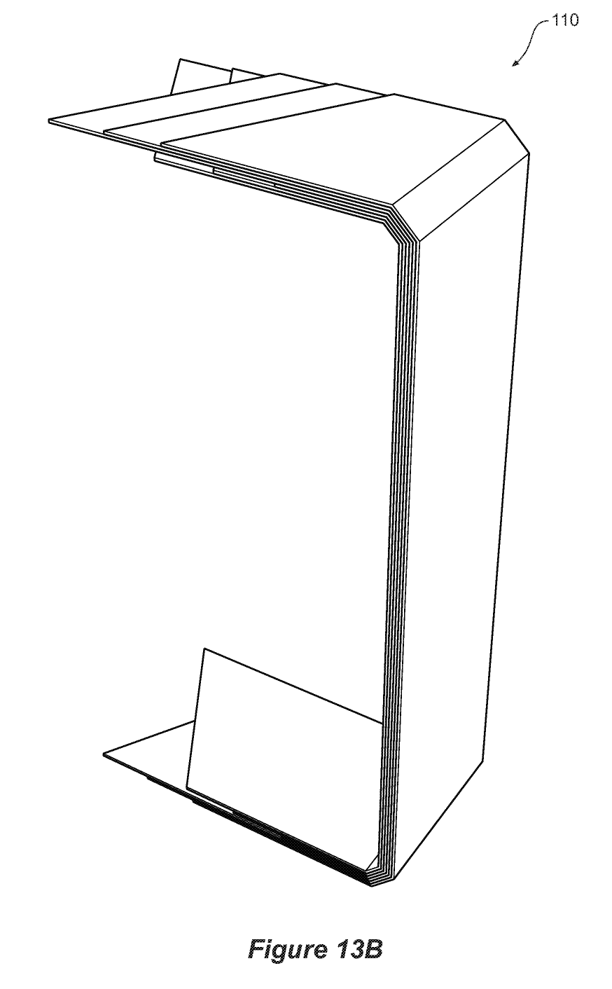

Now referring to FIGS. 13A and 13B, a progressive nesting of packets 10 of laminations from the first embodiment of the invention shown in FIG. 3 and the second embodiment of the invention shown in FIG. 12C are shown. In a preferred method of assembling a transformer core according to the invention, which is described below, a complete core segment 110 is built up to achieve the desired leg thickness 111, such as is shown in FIG. 9 for the second embodiment of the invention, before the second and third segments 120,130 are constructed.

Further embodiments of the invention may have variations of the staggered end edges shown in FIG. 7B. Examples of top views of such further embodiments are shown in FIGS. 7C and 7D. With these embodiments, angles other than 120 degrees may be employed.

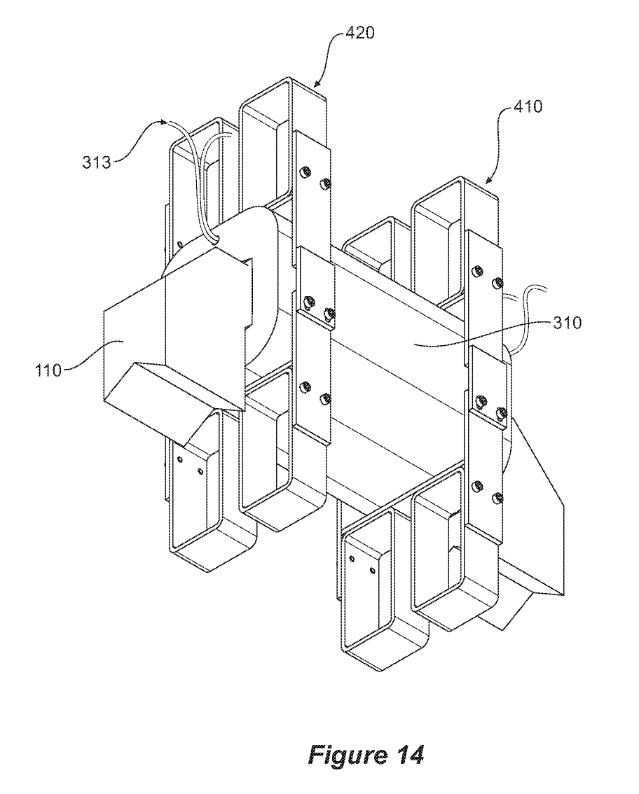

Assembly of a core for a three-phase transformer will now be described with reference to FIGS. 14 to 18.

A pair of support frames such as the frames 410,420 shown in FIG. 14 may be provided to assist with assembly.

A first (bottom) coil 310 (or phase winding) is placed onto the support frames 410,420 shown in FIG. 14. This gives clearance for wires 313 protruding from the coil 310. The coil positioning on the frames 410,420 allows (a bottom) core segment 110 to be put into the coil 310 with packets having their ends facing downwards (a more stable arrangement for this part of the assembly process). Multiple packets at a time can be inserted into the coil 310, tapering off when the space becomes constrained.

After the entire segment 110 has been inserted into the coil 310, packers/spacers are added to ensure the core segment 110 is constrained within the coil 310.

Using the support frames 410,420, the core segment 110 and coil assembly 310 is rotated 180 degrees so that the core segment ends face upwards in the correct orientation for the next assembly steps. This can be done with a suitable lifting apparatus.

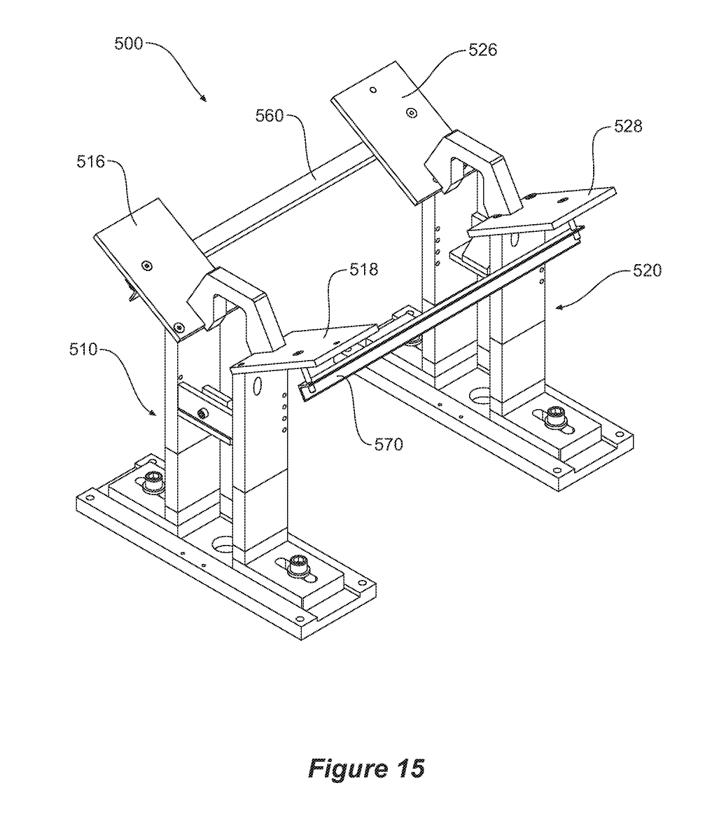

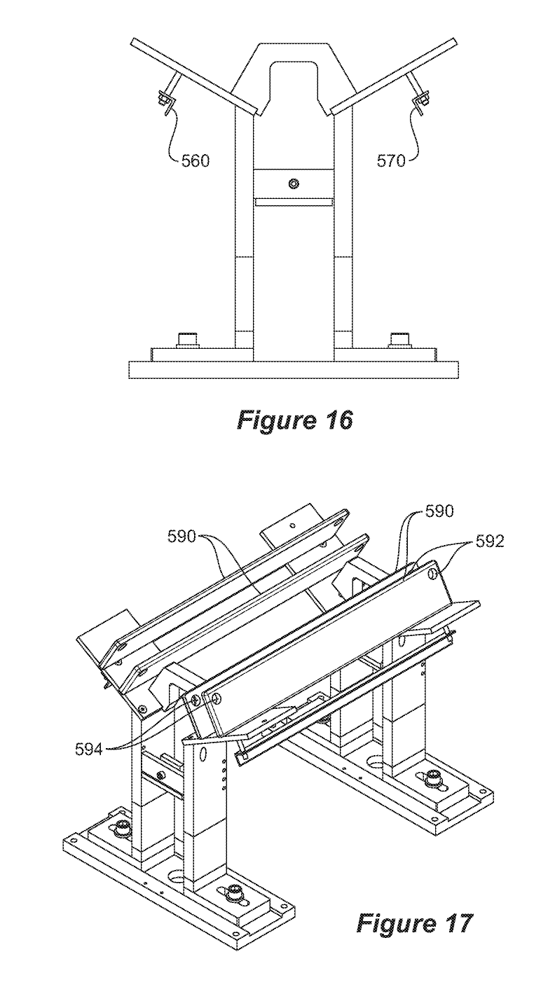

Referring to FIGS. 15 and 16, a transformer assembly apparatus 500 is shown. The apparatus 500 includes a pair of segment end supports 510,520 that can be joined by a pair of spaced apart angled support bars 560,570. These angled support bars 560,570 are for use with the (upper) coils 320,330 which are added to the assembly after the (bottom) coil 310.

The segment end supports 510,520 are placed at either side of the assembly of coil 310 and core segment 110. This transformer assembly apparatus 500, which includes support surfaces 516, 518, 526 and 528, is used to ensure the correct angle is achieved between the coils 310, 320 and 330 and to support the core formed by the core segments 110, 120 and 130 during assembly.

An alignment apparatus, in the form of a pair of spaced apart aluminium plates 590 having the approximate width of the steel of the core legs, is inserted into the two remaining coils 320,330. The plates 590 can be forced apart to make them tight within the coil using a scissor mechanism for instance. Packers/spacers can be inserted at this time to give an accurate representation of positioning. Lifting holes 592 and 594 can be provided within the alignment plates 590 of the alignment apparatus to aid in positioning the coils onto the transformer assembly apparatus 500 as is illustrated in FIG. 17.

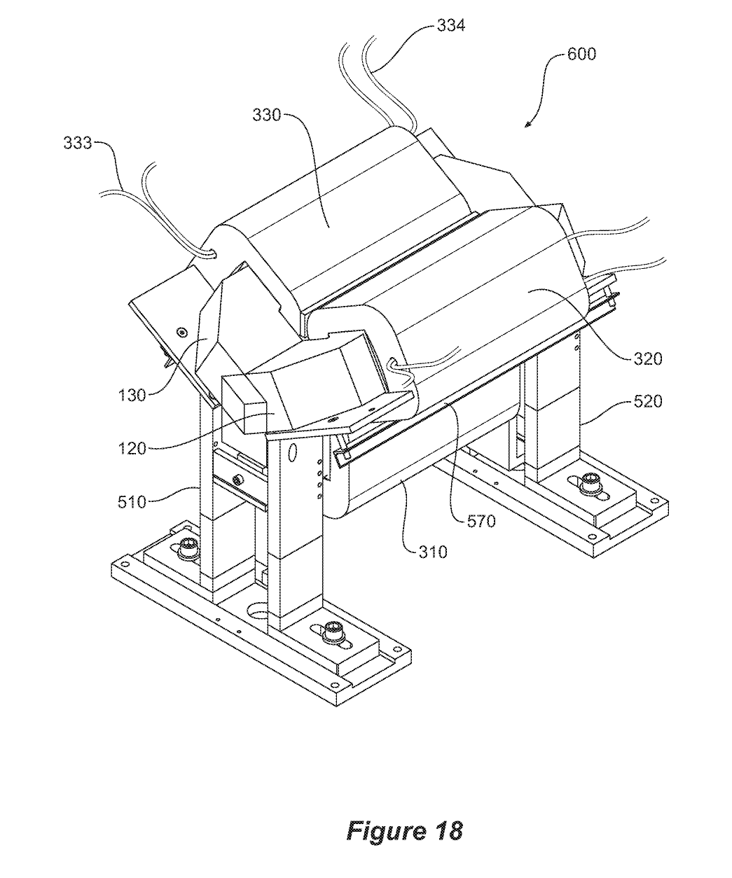

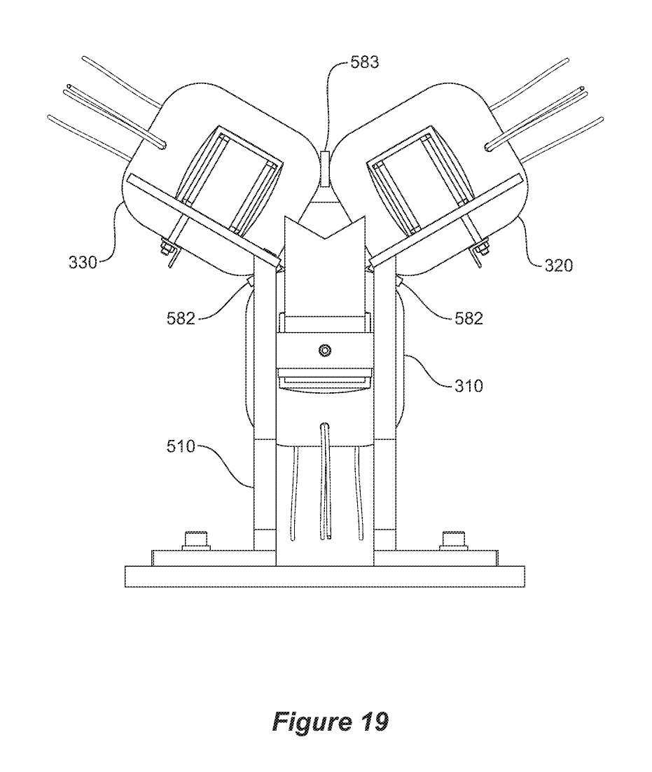

Pieces of insulation forming insulators 581,582,583 are placed between the coils 310, 320 and 330 to achieve a required design spacing, as is shown in FIGS. 18 and 19. A ratchet strap can be used to tighten and hold the positional relationship between the three coils 310, 320 and 330.

Once in position, the angled coil support bars 560,570 shown in FIG. 15 can be tightened just enough to take the weight of the assembly. The aluminium alignment plates 590 can be contracted and removed at this stage.

The first two packets from each third core segment 130 are inserted to ensure correct alignment and support.

Each packet is inserted into the coils following the below sequence:

1. The first packet of segment 120 meets the first packet of segment 110
2. The first packet of segment 130 meets the second packet of segment 110
3. The second packet of segment 120 meets the second packet of segment 130

### 4. Repeat

A single strip of material can be used to aid in the insertion process. One person inserts the packet, while the other pulls the insertion helper lamination slowly to ensure the sharp corners do not get caught.

A built up transformer 600 is shown in FIGS. 18 and 19. Coil 330 has wires 333 and 334 protruding, as is illustrated diagrammatically only. Similarly, coils 310 and 320 have wires protruding.

By way of non-limiting examples, the core 100 may be made from strips of electrical steel, such as grain oriented silicon steel or non-oriented electrical steel. Alternatively, amorphous steel strips may be used to manufacture the core 100. The thickness of the strip material used to produce the laminations 5 may be in the range of 0.01 to 0.35 mm.

The embodiments described herein illustrate that the principles of the present invention may be applied to different transformer cores. In practice, the core will have at least three legs about which conductive coils are to be wound. It is desirable for the legs that receive the coils to have minimal thickness in order to minimise the amount of coil material required (e.g. copper). The build-up or thickness of the core ends or yokes can be increased relative to the thickness of the core leg about which the coils are to be wound in order to lower the magnetic flux density and overall loss of the core. The amount of extra thickness added to lower losses and increase core efficiency must however be balanced against the increased amount of steel (and therefore cost) required to manufacture the core.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A core for a three-phase transformer, the core including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, each core segment formed by nesting together a plurality of magnetic steel strip laminations, the laminations having end sections,
wherein the end sections of the laminations overlap such that the ratio of the thickness of the first core end to the thicknesses of the leg thickness is greater that 1:1 and less than 2:1.

2. The core as claimed in claim 1 wherein the ratio of the thickness of the first end to the thicknesses of the leg thickness is 3:2.

3. The core as claimed in claim 1 wherein the end sections of the laminations abut to form pairs.

4. The core as claimed in claim 3 wherein layers of the pairs of ends of the laminations overlap in a stacked relationship.

5. The core as claimed in claim 1 wherein the core legs are arranged at 120 degrees with respect to each other.

6. The core as claimed in claim 1 wherein the first core end thicknesses matches the second core end thickness and
wherein the core leg thicknesses match each other.

7. The core as claimed in claim 1 wherein each core leg has the same width.

8. The core as claimed in claim 1 wherein the laminations are C-shaped.

9. The core as claimed in claim 1 wherein the laminations are arranged in packets of at least three nested laminations.

10. The core as claimed in claim 9 wherein the laminations of each packet include end edges, the end edges sized and shaped such that their ends are aligned.

11. The core as claimed in claim 9 wherein the laminations of each packet are sized and shaped such that their end edges are staggered.

12. The core as claimed in claim 11 wherein the staggered end edges of the laminations abut to form pairs.

13. The core as claimed in claim 1 wherein each core leg includes a pair of joined core leg portions.

14. A core for three-phase transformer, the core including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, the first and second core end thicknesses being equal, each core segment formed by nesting together a plurality of packets of C-shaped magnetic steel strip laminations, the packets of laminations having end sections,
wherein the end sections of the packets abut to form pairs and pairs of packets overlap such that the ratio of the thickness of the first core end to the thicknesses of the leg thickness is 3:2.

15. The core as claimed in claim 9 wherein the ends of the packets terminate in end edges and the end edges are angled at 120 degrees with respect to edges of the packets.

16. A three-phase transformer, the transformer including:
first, second and third core segments joined together to define three lengthwise extending core legs and first and second core ends disposed generally perpendicularly to the core legs, the core ends arranged to define a Y shape, the core legs having a leg thickness, the first core end having a first core end thickness and the second core end having a second core end thickness, each core segment formed by nesting together a plurality of magnetic steel strip laminations, the laminations having end sections; and
first, second and third coils, the first coil coiled around the first core leg, the second coil coiled around the second core leg and the third coil coiled around the third core leg,
wherein the end sections of the laminations overlap such that the ratio of the thickness of the first core end to the thicknesses of the leg thickness is greater that 1:1 and less than 2:1.

17. The transformer as claimed in claim 16 wherein the ratio of the thickness of the first end to the thicknesses of the leg thickness is 3:2.

18. The transformer as claimed in claim 16 wherein the end sections of the laminations abut to form pairs.

19. The transformer as claimed in claim 18 wherein layers of the pairs of ends of the laminations overlap in a stacked relationship.

20. The transformer as claimed in claim 16 wherein the core legs are arranged at 120 degrees with respect to each other.
